(19) United States
(12) Patent Application Publication
(10) Pub. No.: US 2011/0001361 A1
(43) Pub. Date: Jan. 6, 2011

(54) METHOD FOR SUPPLYING A LOAD WITH ELECTRICAL POWER

(76) Inventor: Christian Appel, Relligen (DE)

Correspondence Address: WHITE & CASE LLP;PATENT DEPARTMENT, 1155 AVENUE OF THE AMERICAS, NEW YORK, NY, 10036, US

(21) Appl. No.: 12/826,818

(22) Filed: Jun. 30, 2010

(30) Foreign Application Priority Data
Jul. 1, 2009 (DE) 102009031422.9-32

(51) Int. Cl. H02J 9/00; H02J 4/00

(52) U.S. Cl. 307/64; 307/75

(57) ABSTRACT

The present invention relates to a method for supplying at least one load with electrical power. The at least one load is in this case supplied with power from an electrical DC voltage source and/or an electrical AC voltage source. According to the invention, a method is provided for supplying electrical power, in particular for supplying electrical power in parallel with a power supply system on a low-voltage power supply system to at least one load, which method is carried out in an electrical installation which has at least an electrical DC voltage source, an inverter, in particular a bidirectional inverter, a measurement apparatus, in particular a power meter which measures an electrical power of the at least one load, an electrical AC voltage source and a control element, wherein the control element has at least one evaluation unit which analyzes measurement data from the at least one measurement apparatus to determine whether the load power is greater than the power available from the DC voltage source, and wherein, when this condition is satisfied, the control element makes an electrically conductive connection (line connection), in particular by means of a switch, between at least the AC voltage source and the at least one load.

The present invention relates to a method for supplying at least one load with electrical power. The at least one load is in this case supplied with power from an electrical DC voltage source and/or an electrical AC voltage source. A control element according to the invention makes an electrically conductive line connection to at least one of the voltage sources, for example taking into account received data. The received data can preset one of the voltage sources and/or may be a function, for example, of a load power. This method makes it possible to ensure that the at least one load is supplied with power independently of only one voltage source, and/or allows the power supply to be configured variably, in a particularly advantageous manner. A particularly advantageous, switchable, electrical line connection can be made to at least one of the voltage sources by the control element by predeterminable switching of the power consumption in each case, in particular taking account of at least one power consumption parameter.

Methods for supplying at least one load are known from the prior art. However, in general, these methods have only one voltage source, either an AC voltage source or a DC voltage source.

By way of example, the supply of a load with electrical power from a public power supply system can be considered to be a method for supplying a load. The public power system, as an AC voltage source, in this case supplies electrical power to loads. For the purposes of this invention, a connection, in particular a building connection, to a power supply system, in particular to a low-voltage power supply system, and preferably a public low-voltage power supply system, can also be considered to be an AC voltage source according to the invention. Other suitable AC voltage sources may, for example, be wind energy installations and/or unit-type district-heating power stations (BHKW) which can supply loads with electrical power when they are operating. The unit-type district-heating power station solutions, in particular, often represent insular solutions, however, since there is no intention of consuming electrical power from a different voltage source or for feeding into a different voltage source. There are various methods of operation for operation of unit-type district-heating power stations, in respect of which, in particular, current-controlled or heat-controlled methods of operation have been implemented.

In the current-controlled method of operation, the unit-type district-heating power station is generally operated when electrical power is drawn from one or more loads. In the heat-controlled method of operation, in contrast, the unit-type district-heating power station is operated as a function of a heat demand of a load or of a household. The electrical energy is generally stored in an energy store when it has not already been completely consumed in parallel by a load. An energy store such as this, generally a rechargeable battery, may represent a DC voltage source for the purposes of the invention.

Other DC voltage sources may, for example, be batteries and/or capacitors, and/or photovoltaic installations. It is likewise known for a load to be supplied with power from a DC voltage source.

The known methods and apparatuses for supplying a load are, however, unsuitable or at least impracticable, since, in particular, no load is supplied from an AC voltage source or a DC voltage source as a function of data and/or at least one power consumption parameter. In addition, no methods are known for controllably supplying electrical power to at least one load.

The present invention is based on the object of providing an improved method and a particularly efficient method for supplying electrical power to at least one load. One object may be the provision of an improved method and/or a particularly efficient method for supplying electrical power to at least one load, and/or from a plurality of power sources.

A further object according to the invention may be to provide improved control for a switchable, electrically conductive line connection. The aim is to make a line connection such as this, in particular via a switch, such that a supplier is connected to one of the voltage sources by predeterminable data and/or as a function of power parameters.

A further object may be to connect at least one load safely and reliably to one of the voltage sources via a switchable, electrically conductive line connection. Preferably and/or in particular when this is advantageous on the basis of power parameters, a link is intended to be made to the DC voltage source. One object according to the invention can therefore also be to minimize the power consumption from an AC voltage source, in particular from a public power supply system, preferably a low-voltage power supply system.

Another object may be to supply the at least one load with electrical power from at least one of the voltage sources, wherein the control system makes a switchable, electrically conductive line connection between the at least one load and one of the voltage sources which is available, and/or is particularly advantageous, in particular on the basis of power consumption parameters. A further object may also be to supply the at least one load with electrical power if one of the voltage sources, in particular an AC voltage source, fails and/or is not being operated. A further object is to provide an improved standby power supply.

The object according to the invention is achieved by a method for supplying at least one load with electrical power having the features of claim 1, or on the basis of an apparatus as claimed in claim 19. Preferred refinements are specified in the dependent claims.

According to the invention, a method is provided for supplying electrical power to at least one load, in particular for a supply in parallel with the power supply system on a low-voltage power supply system, which method is carried out in an electrical installation which at least has an electrical DC voltage source, an inverter, in particular a bidirectional inverter, a measurement apparatus, in particular a power meter which measures an electrical power of the at least one load, an electrical AC voltage source and a control element, wherein the control element has at least one evaluation unit which analyzes measurement data from the at least one measurement apparatus to determine whether the load power is greater than the power available from the DC voltage source, and wherein, when this condition is satisfied, the control element makes an electrically conductive connection (line connection), in particular by means of a switch, between at least the AC voltage source and the at least one load.

According to the invention, a method is also specified for supplying at least one load with electrical power, which method is carried out in an electrical installation which has at least: an electrical DC voltage source, an inverter, in particular a bidirectional inverter, an electrical AC voltage source and a control element, wherein the control element makes a switchable, electrically conductive line connection between at least one of the voltage sources and at least one of the loads, such that feeding takes place from the electrical DC voltage source via the inverter when this is predetermined, in particular by data, preferably by at least one power consumption parameter, and/or when the load power is less than or equal to the power available from the DC voltage source, or is at least partially fed from the electrical DC voltage source via the inverter when the load power is greater than the power available from the DC voltage source and/or is fed from the electrical AC voltage source when this is predetermined, in particular by data, preferably by at least one power consumption parameter, and/or when the load power is greater than the power available from the DC voltage source.

According to the invention, it is possible for at least one of the voltage sources in the electrical installation to supply electrical power to the at least one load, preferably a group of loads, for example in a household.

A voltage source is an apparatus which produces an electrical voltage and/or has an output at a specific voltage.

An AC voltage source of the electrical installation in which the method according to the invention is carried out may be a unit-type district-heating power station, in particular with a disk-type generator, and/or a wind energy installation, in particular with a disk-type generator, and/or a public power supply system. The unit-type district-heating power station and/or the wind energy installation may particularly advantageously have a disk-type generator, preferably a synchronous generator with a short physical length, which produces an AC voltage, in particular a high-frequency AC voltage, preferably an AC voltage at 50 Hertz.

However, other alternative AC voltage sources may also be used in the electrical installation.

In particular, the DC voltage source of the electrical installation may be a battery and/or a rechargeable battery and/or solar cells and/or a photovoltaic element. However, it is particularly preferable to use a rechargeable battery, in particular a lithium-titanate or a lithium-iron-phosphate rechargeable battery. However, alternatively or additionally, it is also possible to use other rechargeable batteries, preferably rechargeable batteries containing lithium, nickel and/or lead. In addition, a capacitor can be used according to the invention as an energy store in the electrical installation. Furthermore, the electrical installation may contain a plurality of energy stores. In one alternative refinement, an energy store, in particular a rechargeable battery, may have a multiplicity of modules and/or cells, in particular also different cell types. In this case, a plurality of modules and/or cells of an energy store could particularly preferably be connected in series and/or in parallel. In one preferred refinement, the energy store may have a heat exchanger. Heat power can be transmitted via this heat exchanger to a heat carrier, in particular a fluid heat carrier, preferably water. The transmitted heat power can preferably be stored in a heat store, and/or can preferably be used for heating purposes, for example in underfloor heating.

In one particularly preferred refinement, the energy store may be of modular design.

The modules according to the invention of the modular energy store can be designed such that a module, in particular each module, is no heavier than 200 kg, in particular no heavier than 150 kg, preferably no heavier than 100 kg, and/or such that the installation space required for the module energy store is less than 2 m², in particular less than 1 m², and preferably less than 0.5 m². The modules according to the invention can preferably be arranged such that the modules can be positioned one above the other and/or can form a common energy store in a mutually interleaved form. The interfaces of the energy store can preferably be adapted such that the modules are no heavier than a predetermined weight, in particular no heavier than 150 kg and/or the base area is no greater than a predetermined area, in particular no greater than 1 m², preferably less than 0.5 m². Furthermore, the interfaces of the energy store can be designed such that complementary connection elements are essentially opposite and are interleaved in one another and/or can be connected by extension elements, in particular can be connected quickly. In this case, a plurality of modules and/or cells of an energy store can particularly preferably be connected in series.

The electrical installation in which the method according to the invention is carried out may in particular contain two inverters, preferably two bidirectional inverters, wherein a first inverter can be connected between the at least one load and the DC voltage source, and a second inverter can be connected between the DC voltage source and a unit-type district-heating power station, in particular a unit-type district-heating power station having a disk-type generator.

In particular, the DC voltage source of the electrical installation may be a battery and/or a rechargeable battery and/or solar cells. In another refinement, the DC voltage source may also be contained in an electric vehicle, in particular an electric car, an electric motor cycle, an electric water craft and/or in any other apparatus having an energy store. For one particularly preferred embodiment, an electric vehicle, in particular having an energy store, may represent a DC voltage source according to the invention. This also means that an electric vehicle may be part of the electrical installation. The DC voltage source, in particular the energy store, preferably the energy store of an electric vehicle, can transmit the electrical power, in particular the stored electrical energy, to the installation according to the invention, and/or can feed another voltage source, in particular an AC voltage source, preferably a public power supply system. The DC voltage source, preferably contained in an electric vehicle and/or an electric vehicle having an energy store, can therefore transmit electrical power to another voltage source, preferably for example also via an inverter, to an AC voltage source, in particular to a power supply system and/or can transmit electrical power from another voltage source. Furthermore, according to the invention, it is also possible for an electric vehicle to be connected to an electrical installation at times in which, for example, it is parked, is not moving and/or is not being operated, and to make the electrical power, in particular the stored electrical energy, and/or the capacity of the energy store in the electric vehicle available to this installation. In this case, the user of an electric vehicle can particularly preferably preset, for example, when he wishes to use the electric vehicle, in particular with what state of charge of the energy store. In the meantime, in particular when the electric vehicle is not being operated, is not moving and/or is parked, the control system and/or the control center of the electrical installation can use the capacity of the energy store and/or the stored energy in the energy store, and/or can make it available in the electrical installation. The energy store in the electric vehicle may be used as a DC voltage source according to the invention. This also means that the control system can make and/or control line connections to the energy store, in particular to the energy store contained in an electric vehicle.

However, it is particularly preferable to use a rechargeable battery, in particular a lithium-iron-phosphate rechargeable battery. However, alternatively or additionally, it is also possible to use other rechargeable batteries, preferably rechargeable batteries containing lithium, nickel and/or lead. According to the invention, it is also possible to use a capacitor as an energy store in the electrical installation. In one particularly preferred refinement, the electrical installation may have an electrical energy store, in particular a rechargeable battery, and a capacitor. The capacitor can emit electrical power, in particular electrical energy stored in advance in the capacitor, to the electrical installation, preferably on reaching or exceeding a threshold value, in particular for the power consumption of the at least one load.

The at least one DC voltage source can be connected via an inverter, in particular a bidirectional inverter, to the at least one AC voltage source. For example, electrical power can thus be fed from one voltage source, for example from an AC voltage source, to another voltage source, for example to another AC voltage source, and/or via at least one inverter to a DC voltage source.

It may be particularly advantageous for the AC voltage source to have at least one unit-type district-heating power station. In this case, according to the invention, electrical power can be fed from the AC voltage source, in particular from a unit-type district-heating power station and/or a wind energy installation and/or a photovoltaic installation and/or a public power supply system, via an inverter to the DC voltage source, preferably to an energy store. The DC voltage source, in particular the at least one energy store, preferably a rechargeable battery, can thus be charged with electrical energy. In this case, the energy store can particularly advantageously be charged completely with electrical energy from a unit-type district-heating power station and/or a wind energy installation and/or a photovoltaic installation.

However, it is also possible according to the invention for electrical power to be fed into an AC voltage source or into an AC voltage power supply system from a DC voltage source via an inverter, in particular a bidirectional inverter.

According to the invention, the control element makes a switchable electrically conductive line connection between at least one of the voltage sources and at least one of the loads, such that power is fed from the electrical DC voltage source via the inverter when this is predetermined, in particular by data, preferably by at least one power consumption parameter, and/or when the load power is less than or equal to the power available from the DC voltage source, or is fed at least partially from the electrical DC voltage source via the inverter when the load power is greater than the power available from the DC voltage source and/or is fed from the electrical AC voltage source when this is predetermined in particular by data, preferably by at least one power consumption parameter, and/or when the load power is greater than the power available from the DC voltage source.

In this case, the control element can control a switch, the making of a contact, preferably of a switching contact of an electrically conductive connection, in particular by means of the control system. According to the invention, a method is provided for supplying at least one load, preferably a load group, with electrical power, which method is carried out in an electrical installation, preferably in an electrical household installation, which is furthermore characterized by the features of the main claim. A load group may in this case comprise a multiplicity of loads. In this case, in particular, these loads can be connected in parallel and/or in series via electrically conductive line connections.

The control element can make a switchable, electrically conductive line connection between the at least one load and one of the voltage sources, preferably by controlling a switching element, in particular an electrical switch. A line connection such as this between, for example, the at least one DC voltage source and the at least one load can in particular be controlled when data and/or when at least one power consumption parameter predetermine or predetermines a line connection such as this. The power consumption parameters may be parameters of the at least one load and/or parameters which are characterized by the time, in particular the time of day and/or the clock time, and/or states, in particular operating states, for example of a unit-type district-heating power station and/or of a wind energy installation and/or of a photovoltaic installation and/or of an alternative voltage source, in particular an AC voltage source. Average and/or projected energy consumption data of the at least one load, in particular taking account of a time profile over the day, can also be regarded as data as power consumption parameters and can preferably preset the control of the control element and/or switching and/or making of the electrically conductive line connection. In addition, the control element can make and/or change a corresponding switchable line connection, in particular predetermined by data which can be received.

Prices, in particular electricity prices or power consumption prices, such as power supply system fees and/or other payments, could also have an influence as power consumption parameters on the control element and/or the switchable line connection.

According to the invention, it is possible for the control element to make a switchable, electrically conductive connection between the load and at least one of the voltage sources when data, in particular stored and/or received data, presets at least one of the voltage sources, in particular an AC voltage source or a DC voltage source. This data can also transmit and/or preset operating plans for the unit-type district-heating power station and/or switching plans for the control element, in particular at what time power is intended to be fed from which voltage source and/or in particular also at what time electrical power is intended to be transmitted from one voltage source, preferably from an AC voltage source, to another voltage source, preferably to a DC voltage source.

The electrical installation in which the method according to the invention can be carried out may contain a measurement apparatus, in particular a power meter, and preferably an intelligent meter (smart meter). In particular, a meter such as this can measure the power of the at least one load and/or show the respective instantaneous consumption of electrical power and/or a profile of the power consumption over a period, in particular a time period. In addition, a measurement apparatus such as this can store, in particular, the data generated by the measurement apparatus. An intelligent meter can be equipped with additional functions. The meter data can be transmitted, for example via a radio network and/or a mobile telephone network and/or the Internet, in particular to a control center and/or to the control element for the electrical installation. In addition to the demand for electrical energy, the measurement apparatus, in particular an intelligent meter, can also measure load peaks of the at least one load and/or load group, and, in particular at times of such load peaks, can store and/or transmit data, in particular to a control center and/or to the control element of the electrical installation. The load peaks can be identified by the measurement apparatus and/or the control unit and/or a control center, in particular by alignment with threshold values and/or average power consumption values. At times of such load peaks, the control unit can make an electrical line connection to at least one of the voltage sources, in particular via at least one switch, and can thus control an advantageous supply to the load, for example from a DC voltage source.

In addition, in one alternative embodiment, the measurement apparatus can receive data and/or transmit data. Such data transmission can preferably be carried out wirelessly. In one alternative embodiment, the data can be transmitted to a receiver via a data line. The data receiver can preferably be a control element according to the invention and/or a control center, in particular of the operator of the electrical installation. The data from the measurement apparatuses can also be stored and/or can be transmitted to a receiver, in time intervals, in particular periodic time intervals. By way of example, an advantageous receiver may also be a central control unit and/or a control center, in particular a superordinate control center, preferably of the operator of the electrical installation and/or of the operator of the method according to the invention.

The data can be received from a multiplicity of electrical installations and/or can be processed, in particularly jointly, in a control center such as this. According to the invention, it is thus also possible for methods according to the invention which are carried out essentially at the same time to be controlled for example in a multiplicity of electrical installations by one central control unit, in particular a control center, preferably by the operator of the electrical installations. It could therefore be particularly advantageous to carry out the method according to the invention in a multiplicity of electrical installations. This would make it possible to achieve the object of feeding electrical power into a system, preferably a system which connects the multiplicity of electrical installations, for example a power supply system, in particular at predeterminable times or in predetermined time periods. For example, electrical power peaks could in this way be counteracted by feeding in power, in particular deliberately. Electrical power could also particularly advantageously be transmitted and/or fed from an electrical installation or an installation group, in which a method according to the invention is carried out, for example into an AC voltage source, preferably essentially at the same time. A feed such as this could be carried out in particular at times in which load peaks occur in the system, for example in a power supply system, and/or electrical power is demanded from at least one load or load group, and/or a comparatively high price can be achieved for electrical energy.

A control element according to the invention can in one preferred embodiment receive and/or store data, in particular from a measurement apparatus and/or a control center. The control element controls the making of an electrically conductive line connection, in particular taking into account this data. The data, in particular received data, can predetermine at least one of the voltage sources to which a switchable, electrically conductive line connection is intended to be made. In addition, in one preferred embodiment of the method according to the invention, it may be advantageous for a data processing apparatus, in particular a computation unit, to process the data, in particular received data, before transmission to the control element.

In particular, the switchable, electrically conductive line connection can be made between the at least one load and in particular one of the voltage sources. In another embodiment, it may be advantageous for a line connection to be made, in particular by means of at least one inverter, to an AC voltage source and to a DC voltage source.

In one preferred embodiment of the method, the control element can control electrical power being fed into the DC voltage source and/or into the AC voltage source. By way of example, the control element can make a switchable, electrically conductive line connection such that electrical power can be transmitted from an AC voltage source via an inverter, in particular a bidirectional inverter, into an electrical energy store, in particular into a DC voltage source. In one alternative way of carrying out the method according to the invention, electrical power can likewise be fed from a DC voltage source, via at least one inverter, in particular a bidirectional inverter, into an AC voltage system, in particular into a power supply system.

According to the invention, the electrical installation in which the method is carried out for supplying the at least one load is preferably also in the form of a standby power supply. For example, it may be advantageous, as soon as one of the voltage sources which cannot cover the supply of the demanded electrical power to the load, for example, an AC voltage source, and in particular the public power supply system, for the electrical power first of all to be fed from the DC voltage source, in particular from an energy store, before, for example, operating a unit-type district-heating power station or some other standby power supply. In particular, this can also ensure that electrical power is supplied virtually without any interruption. This supply with virtually no interruption frequently represents a problem in the case of standby power supply systems according to the prior art, because conventional emergency power supplies, generally internal combustion engines, have a starting-up time during which no electrical power can still be emitted. The standby power supply according to the invention can bridge a starting-up time such as this, or can bridge disconnection times of the previously supplied AC voltage source which last for only a short time. In particular, when one of the voltage sources is disconnected for only a short time, this makes it possible to avoid comparatively complex starting of a standby power supply.

These and further features and advantages of the present invention will be described in more detail with reference to the attached drawings of exemplary embodiments of the present invention. In the drawings:

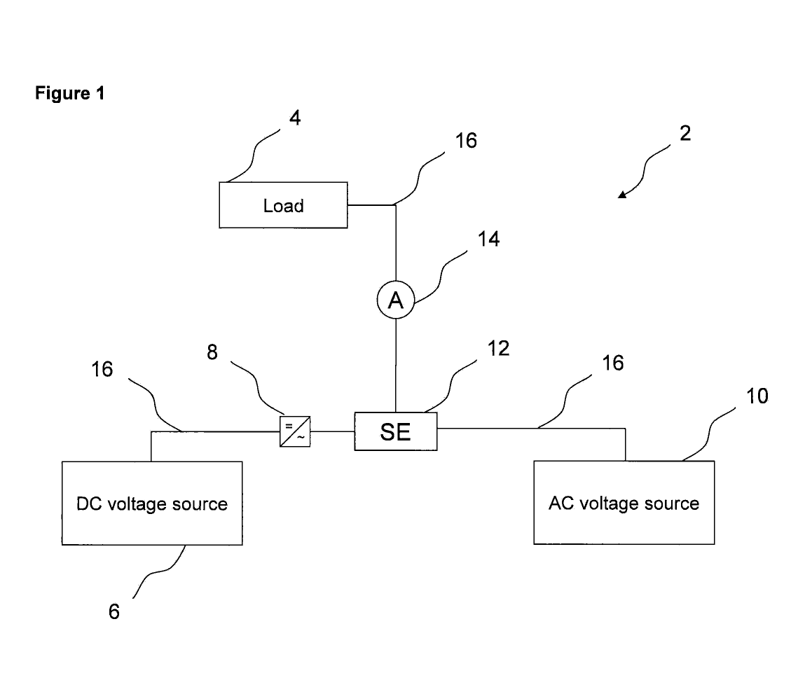

FIG. 1 shows an electrical installation in which the method according to the invention can be carried out,

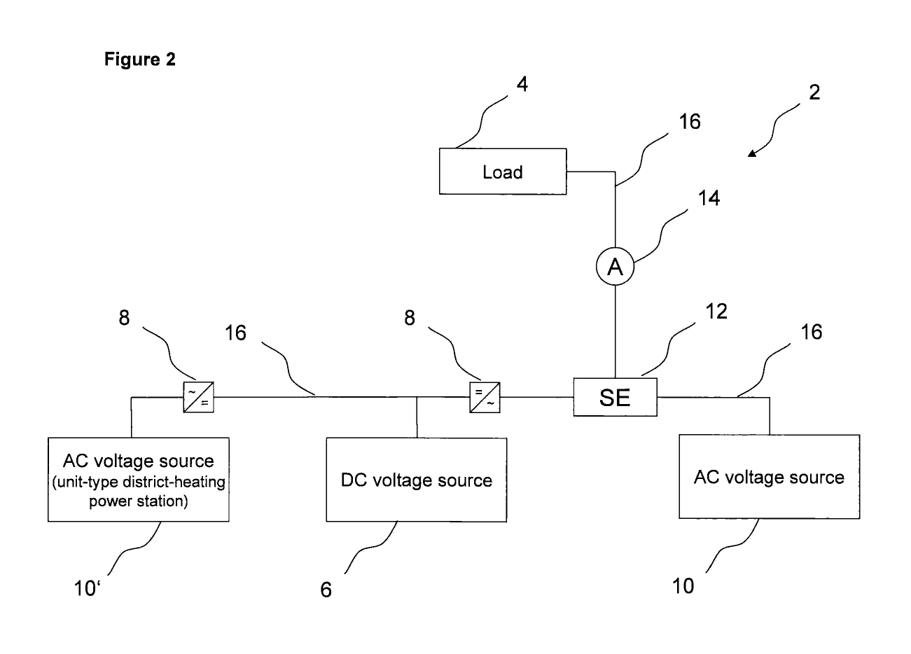

FIG. 2 shows one alternative embodiment of the electrical installation,

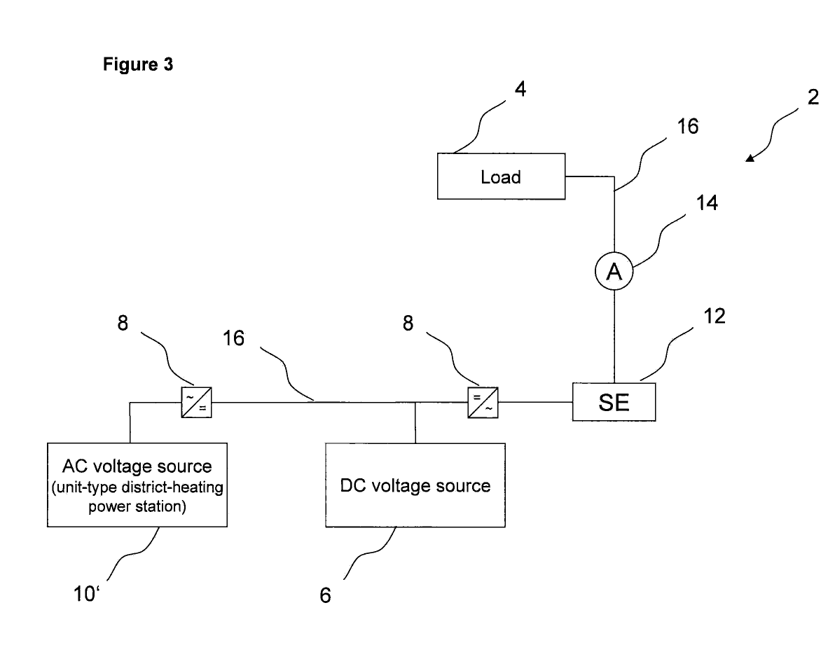

FIG. 3 shows a further alternative embodiment of the electrical installation,

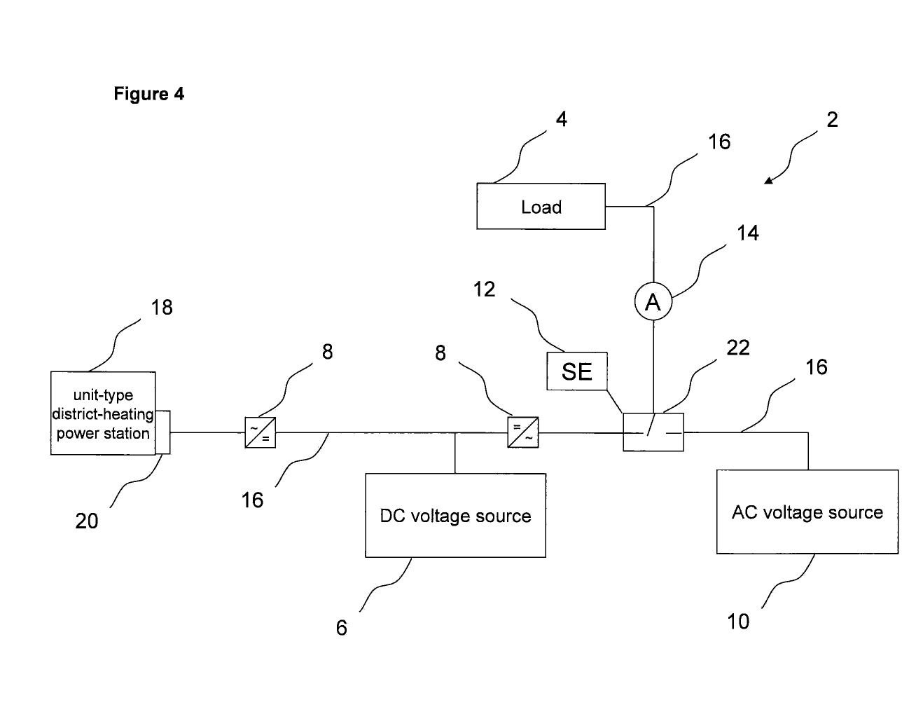

FIG. 4 shows one preferred embodiment of the electrical installation, and

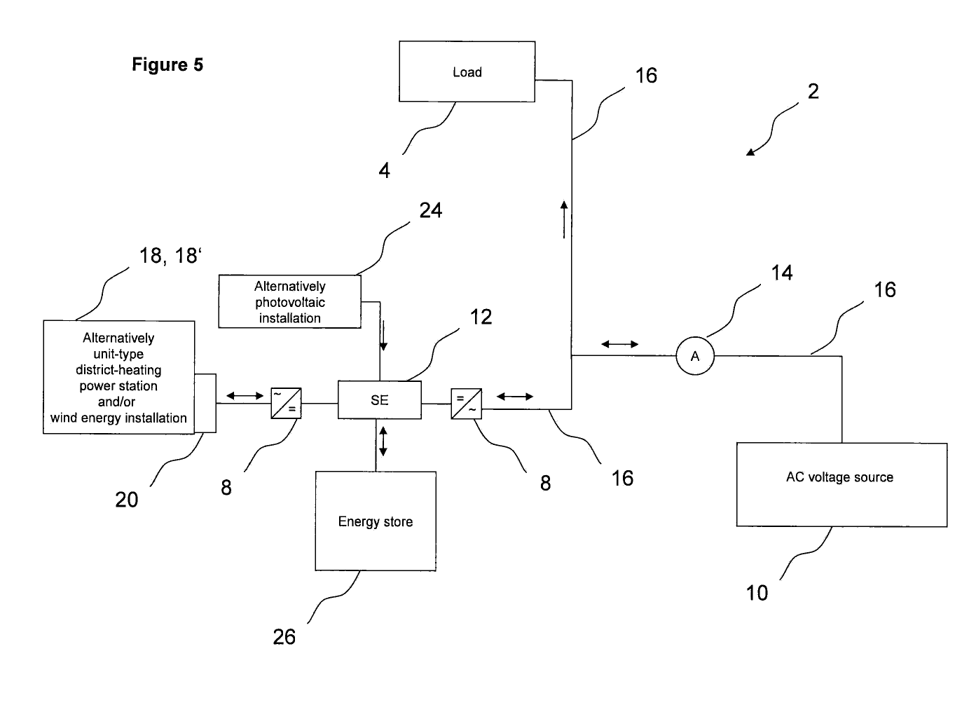

FIG. 5 shows a further preferred embodiment of the electrical installation.

FIG. 1 shows an electrical installation 2 in which the method according to the invention can be carried out. In this case, the electrical installation 2 has at least one load 4, an electrical DC voltage source 6, an inverter 8, in particular a bidirectional inverter, an electrical AC voltage source 10 and a control element 12. Furthermore, a measurement apparatus 14 is connected between the voltage sources 6, 10 and the electrical load 4 in the electrical installation. In this case, the measurement apparatus A can measure the electrical power consumption of the at least one load and can generate data which the measurement apparatus can, in particular, store and/or transmit, in particular to a control center, in particular located outside the electrical installation, and/or to the control element SE of the electrical installation.

The control center (not illustrated) and/or the control element 12 can, in particular, process this received data and can particularly advantageously control the electrical installation 2, in particular as a function of power consumption parameters. In this case, the control element 12 can preferably control at least one switch which makes an electrically conductive line connection 16 to at least one of the voltage sources 6, 10. The choice of the voltage source can preferably be dependent on the data, in particular on the power consumption parameters. By way of example, a computation unit can compare in particular the values measured by the measurement apparatus 14 with stored data, and/or can transmit data to the control element 12 when threshold values are exceeded. The control element 12 can then make a switchable, electrically conductive line connection 16, for example by controlling a switch. In particular, one particularly advantageous control system can be distinguished in that the consumption of electrical power, for example as soon as a threshold value is exceeded, and in particular at times of power peaks, can advantageously be fed at least partially from the DC voltage source 6. The control according to the invention of the method makes it possible to reduce a supply of electrical power to the at least one load 4 from the AC voltage source 10, in particular at times when a threshold value is exceeded, for example a threshold value relating to the energy consumption price and/or power supply system fees, and/or to avoid this, in particular when predetermined threshold values are exceeded. In this case, threshold values may also be times, in particular times of day and/or clock times, that is to say a line connection 16 is made between the load 4 and at least essentially only one of the voltage sources 6, 10, preferably the DC voltage source 6 or the AC voltage source 10, for example at specific times of day and/or clock times. It is also in this way possible to bridge times in which, for example, maintenance work is being carried out on the AC voltage source 10, and/or the AC voltage source 10 is not available. The apparatus for the method according to the invention can therefore supply the load with electrical power even when one of the voltage sources 6, 10 has failed. The apparatus according to the invention for the method is an emergency power supply that has been improved in comparison to the prior art.

In a further method process, electrical power can be fed into the DC voltage source 6, in particular into an energy store, via at least one electrically conductive line connection 16, in particular from the AC voltage source 10 via the at least one inverter, in particular bidirectional inverter, 8. This allows the energy store, in particular a rechargeable battery and/or a capacitor, to be charged with electrical energy. In particular, such feeding of electrical power, in particular from an AC voltage source 10, preferably from a public power supply system and/or from a unit-type district-heating power station, in particular with a disk-type generator, into an energy store can be carried out in particular at advantageous times when at least one threshold value, for example a threshold value relating to an energy consumption price and/or power supply system fees, is undershot. In this case, advantageous times may, in particular, be times when, for example, the unit-type district-heating power station is being operated and/or electrical power is available from a power supply system, in particular a public power supply system, and/or electrical power is available, preferably at low cost, in particular compared with a threshold value for the energy consumption price, and/or at predetermined times, in particular during the night time.

FIG. 2 shows an electrical installation 2 which, in contrast to FIG. 1, contains an alternative AC voltage source 10′, in particular a unit-type district-heating power station. The alternative AC voltage source 10′ may, in particular, be a unit-time district-heating power station, although in an alternative refinement it may also advantageously be another AC voltage source.

In this case, the AC voltage source 10′ is connected via an inverter 8, in particular a bidirectional inverter, to the DC voltage source 6, in particular to an energy store, and preferably to a rechargeable battery. The electrical power can be transmitted via the at least one inverter 8 from one voltage source to another of the voltage sources and/or to the at least one load 4. For example, according to the invention, it is possible to feed electrical power from one AC voltage source 10′, in particular from a unit-type district-heating power station, preferably via at least one inverter 8, into the DC voltage source 6, preferably into an energy store, and/or, in particular via a second inverter 8, into an AC voltage source 10, in particular into a public power supply system.

It may also be advantageous to transmit electrical power from one AC voltage source 10, in particular from a public power supply system, and/or a DC voltage source 6 via at least one inverter 8 to the other AC voltage source 10′, in particular to the unit-type district-heating power station.

This electrical power transmitted in this way can be used, for example, to start the unit-type district-heating power station.

FIG. 3 shows an electrical installation 2 which, in contrast to FIG. 2, contains only one AC voltage source 10′, in particular a unit-type district-heating power station. The AC voltage source 10′, preferably a unit-type district-heating power station, is in this case connected via an inverter 8, in particular a bidirectional inverter, to the DC voltage source 6, in particular to an energy store, and preferably to a rechargeable battery. Furthermore, an electrical line connection 16 exists with at least one inverter 8, in particular a bidirectional inverter, to the at least one load 4. The electrical line connection 16 is switchable and can be controlled by the at least one control element 12. In addition, a measurement apparatus 14 is provided between the at least one load 4 and the control element 12 in the electrical installation 2 shown in FIG. 3.

In this electrical installation 2, the electrical power for supplying the at least one load 4 can be drawn, for example, from the AC voltage source 10′, in particular the unit-type district-heating power station. For example, when the unit-type district-heating power station is being operated, electrical power, in particular an AC voltage, can be converted via an inverter 8 to a DC voltage. This DC voltage can in turn be stored in a DC voltage source 6, preferably an energy store, and in particular a rechargeable battery, and/or can be converted via an inverter, in particular a second inverter, 8 to an AC voltage which is suitable for supplying the at least one load 4.

FIG. 4 shows an electrical installation 2 which, in a manner comparable to FIG. 2, has a unit-type district-heating power station 18 with a disk-type generator 20.

In this electrical installation 2, the electrical power can be drawn, for example, from the unit-type district-heating power station 18 with the disk-type generator 20 in order to supply the at least one load. By way of example, when the unit-type district-heating power station 18 is being operated, electrical power, in particular an AC voltage, can be converted to a DC voltage via an inverter 8. This DC voltage can in turn be stored in a DC voltage source 6, preferably an energy store, and in particular a rechargeable battery, and/or can be converted via an inverter, in particular a second inverter, 8, to an AC voltage, which is suitable for supplying the at least one load 4 and/or for feeding electrical power into an AC voltage source 10, preferably into a power supply system, in particular a public power supply system.

In this electrical installation 2, a control element 12 according to the invention is provided, which controls a switch 22 which makes an electrical line connection 16 between the voltage sources 6, 10, 18 and/or at least one of the voltage sources 6, 10, 18 and the load 4. In one alternative embodiment, the electrical installation 2 may also have a multiplicity of switches 22, which can each be used to switch one of the voltage sources 6, 10, 18. The control element 12 according to the invention can receive data, in particular from the at least one measurement apparatus 14 and/or from a control center, and can control the electrical installation 2 with the aid of the measured data, of the at least one power parameter, and/or predetermined data. The at least one load 4 is therefore supplied with electrical power, in particular independently of only one voltage source 6, 10, 18.

FIG. 5 shows a preferred electrical installation 2 for the method according to the invention. In this electrical installation 2, the at least one load 4 can be supplied from various voltage sources 6, 10, 18, 18′, 24. The electrical installation in FIG. 5 contains at least one AC voltage source 10 which may be represented by a public power supply system, in particular a low-voltage power supply system. Furthermore, the installation has a unit-type district-heating power station 18 and/or a wind energy installation 18′, which can preferably have a disk-type generator 20 which generates an AC voltage. In addition, a photovoltaic installation 24 may be included as a DC voltage source. For the purposes of the invention, a further DC voltage source is represented by an energy store 26, preferably a rechargeable battery, which in one alternative embodiment may be contained, for example, in a vehicle.

In the case of this electrical installation 2, the electrical power for supplying the at least one load 4 can also be drawn, for example, from the unit-type district-heating power station 18 and/or the wind energy installation 18′, in particular in each case having a disk-type generator 20. For example, when the unit-type district-heating power station 18 is being operated, electrical power, in particular an AC voltage, can be converted via an inverter 8 to a DC voltage. This DC voltage can in turn be stored in an energy store 26, in particular a rechargeable battery, and/or can be converted to an AC voltage via an inverter, in particular a second inverter, 8. In addition, a photovoltaic installation 24 can produce a DC voltage which, in particular via an inverter 8, is suitable for supplying the at least one load 4 and/or for feeding electrical power into an AC voltage source 10, preferably into a power supply system, in particular a public power supply system. A control element 12 according to the invention, in particular also containing the measurement apparatus according to the invention, can in this case make the electrical connection between at least one voltage source 6, 10, 18, 18′, 24 and the at least one load 4. In this case, the control element 12 according to the invention can control the making of the line connections, for example via a switch, in particular taking account of the power consumption parameters and/or the values measured by the measurement apparatus.

Furthermore, the electrical installation contains a measurement apparatus 14 which is connected downstream from one AC voltage source 10 and is intended to measure a consumption and/or the feeding in of electrical power, in particular from this AC voltage source 10.

1. A method for supplying at least one load with electrical power, which method is carried out in an electrical installation which has at least: an electrical DC voltage source, an inverter, in particular a bidirectional inverter, a measurement apparatus, in particular a power meter, which measures an electrical power of the at least one load, an electrical AC voltage source and a control element, wherein the control element has at least one evaluation unit which analyzes measurement data from the at least one measurement apparatus to determine whether the load power is greater than the power available from the DC voltage source, and wherein, when this condition is satisfied, the control element makes an electrically conductive connection (line connection), in particular by means of a switch, between at least the AC voltage source and the at least one load.

2. The method for supplying at least one load as claimed in claim 1, wherein the control unit switchably makes an electrically conductive line connection between at least one of the voltage sources and at least one of the loads, such that the at least one load is fed from the electrical DC voltage source via the inverter when this connection is predetermined, in particular by data, preferably by at least one power consumption parameter, and/or when the load power is less than or equal to the power available from the DC voltage source, or is fed at least partially from the electrical DC voltage source via the inverter when the load power is greater than the power available from the DC voltage source, and/or is fed from the electrical AC voltage source when this connection is predetermined, in particular by data, preferably by at least one power consumption parameter.

3. The method as claimed in one of the preceding claims, wherein the supply to the at least one load is a supply in parallel with a power supply system, in particular on a low-voltage power supply system.

4. The method as claimed in one of the preceding claims, wherein the electrical installation has a measurement apparatus, in particular a power meter, in particular for measuring an electrical power of the at least one load.

5. The method as claimed in one of the preceding claims, wherein the electrical installation has a transformer and/or a step-up controller (step-up converter).

6. The method as claimed in one of the preceding claims, wherein data is transmitted from the measurement apparatus, in particular via a data line or wirelessly, to a receiver.

7. The method as claimed in one of the preceding claims, wherein the control unit receives data, in particular data from the measurement apparatus, preferably relating to at least one power consumption parameter, which data presets at least one of the voltage sources.

8. The method as claimed in one of the preceding claims, wherein the control element makes the switchable, electrically conductive line connection between the DC voltage source and the at least one load when the received data presets a power consumption from the DC voltage source.

9. The method as claimed in one of the preceding claims, wherein the control element bidirectionally controls an electrical power feed into the DC voltage source and/or into the AC voltage source.

10. The method as claimed in one of the preceding claims, wherein the electrical DC voltage source has an energy store.

11. The method as claimed in one of the preceding claims, wherein the energy store has a rechargeable battery, in particular a lithium-ion rechargeable battery, particularly preferably a lithium-titanate rechargeable battery, preferably a lithium-iron-phosphate rechargeable battery, and/or in particular a rechargeable battery containing lead and/or nickel.

12. The method as claimed in one of the preceding claims, wherein the energy store has a capacitor.

13. The method as claimed in one of the preceding claims, wherein the energy store can store an amount of energy, in particular electrical energy, which in particular is substantially greater than or equal to the amount which corresponds to a daily energy consumption of the at least one load.

14. The method as claimed in one of the preceding claims, wherein the energy store is less than the daily energy consumption of the at least one load.

15. The method as claimed in one of the preceding claims, characterized in that power is transmitted to the at least one load substantially or exclusively from the energy store, in particular from the rechargeable battery.

16. The method as claimed in one of the preceding claims, wherein the energy store can be charged from an AC voltage source, in particular a household-internal AC voltage source, in particular from a unit-type district-heating power station and/or a photovoltaic installation and/or a wind energy installation.

17. The method as claimed in one of the preceding claims, wherein the unit-type district-heating power station, in particular a household internal unit-type district heating power station, has a disk-type generator which generates an AC voltage output, in particular a high-frequency AC voltage, which is preferably ≧50 Hertz.

18. The method as claimed in one of the preceding claims, wherein the at least one second inverter, in particular a bidirectional inverter, is connected between the disk-type generator of the unit-type district-heating power station and the DC voltage source.

19. The method as claimed in one of the preceding claims, wherein at least one inverter converts direct current which can be used to charge the energy store.

20. The method as claimed in one of the preceding claims, wherein the direct current from the DC voltage source is converted by the inverter to an AC voltage, preferably to an AC voltage of 400 V and/or 230 V, in particular at a frequency of ≧50 Hz.

21. The method as claimed in one of the preceding claims, wherein the energy store is charged from the AC voltage source at predeterminable times, in particular during the night time, and/or during operating times of the unit-type district-heating power station and/or of the photovoltaic installation and/or of the wind energy installation.

22. An apparatus for the method as claimed in one of the preceding claims, in particular as standby power supply.
